(19) United States
(12) Patent Application Publication
(10) Pub. No.: US 2022/0006637 A1
(43) Pub. Date: Jan. 6, 2022

(54) FILE SYSTEM SUPPORTING REMOTE ATTESTATION-BASED SECRETS

(71) Applicant: Intel Corporation, Santa Clara, CA (US)

(72) Inventor: Bryon S. Nevis, Portland, OR (US)

(73) Assignee: Intel Corporation, Santa Clara, CA (US)

(21) Appl. No.: 17/477,495

(22) Filed: Sep. 16, 2021

(51) Int. Cl. H04L 9/32; G06F 16/188

(52) U.S. Cl. CPC H04L 9/3234; G06F 16/188

(57) ABSTRACT

An operating system kernel receives a request from an application to access a secret, the application and the operating system kernel executing in a first trust domain; and an attestation-based secrets manager receives the request from the operating system kernel, validates the request using remote attestation, gets the secret from a secure storage in the second trust domain when the request is validated, and sends the secret from the second trust domain to the operating system kernel, the attestation-based secrets manager executing in a second trust domain; wherein the operating system kernel then sends the secret to the application.

### FIELD

Embodiments relate generally to computer security, and more particularly, to protecting filesystem-based secrets in computing systems.

### BACKGROUND

In some instances, a computer program stores sensitive information in cleartext in a file or on disk. The sensitive information could be read by attackers with access to the file, or with physical or administrator access to the disk. Even if the information is encoded in a way that is not human-readable, certain techniques could determine which encoding is being used and then decode the information. Any computing architecture that stores secrets in cleartext on a file system may be vulnerable. These secrets are at greater risk in edge deployments because of easy physical access to computing system hardware as compared to a datacenter or cloud computing deployment where access to the program is controlled by a physical or virtual data center.

Previous approaches to solving this problem exhibit several disadvantages. Previous approaches use obsolete or broken cryptographic processes, depend on existing filesystem-based secrets to function, require manually entered encryption keys, and/or do not attempt to authenticate a program that is opening a file containing cleartext information. These previous approaches implicitly trust the host operating system (OS), which may be compromised.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 is a diagram of a computing arrangement according to some embodiments.

FIG. 2 is a block diagram of a computing system having a filesystem supporting remote attestation-based secrets according to some embodiments.

FIG. 3 is a flow diagram of remote attestation-based secrets processing according to some embodiments.

FIG. 4 is a flow diagram of remote attestation-based secrets processing according to some embodiments.

FIG. 5 is a schematic diagram of an illustrative electronic computing device to perform remote attestation-based secrets processing according to some embodiments.

### DETAILED DESCRIPTION

Implementations of the technology described herein provide a method and system that uses a remote attestation-based authentication mechanism mediated by an operating system (OS) kernel to ensure that filesystem-based secrets are delivered on-demand to authenticated computer programs. Since the OS kernel is part of a secure boot chain of trust for a computing system, this mechanism deters the delivery of secrets to unauthorized programs. This mechanism also deters online cloning attacks whereby a privileged software adversary copies files out of a mounted filesystem.

In an embodiment, the OS is any version of Linux™, although in other embodiments, other OSs may be used (such as Windows®) may be used.

In an embodiment, the technology described herein uses a Linux™ filesystem in user space (FUSE) file system driver program (called a secrets filesystem provider herein) to receive a request to access a filesystem-based secret and forward the request to an attestation-based secrets manager that uses remote attestation (based at least in part on additional capabilities provided by a trusted platform module (TPM)) to validate the request. This technology uses the ability of a FUSE subsystem to obtain metadata about the request (such as the requesting process identifier (ID), effective user ID, executable name, namespace information, etc.), a Linux™ integrity measurement architecture (IMA) subsystem to provide attested measurements of the requester and of the request itself and relies on an implementation where the Linux™ kernel is part of the secure boot chain of trust. Attestation data is used by the attestation-based secrets manager to authorize delivery of the secret to the requestor on a request-by-request basis.

Embodiments provide protection of cleartext storage of secrets in a filesystem for application programs in a generic way without requiring code changes in the application programs. Cleartext storage for computing systems running Linux™, for example, may occur because there is no OS-supported cryptographic application programming interface (API) for the protection of secrets. As a result, application programs that implement security features such as encryption or signing on computing systems running Linux™ often store keys on the filesystem, while relying on file permissions and access control lists (both discretionary and mandatory) for security. These protections may be weak, as it may be possible with physical or virtual access to physical computing hardware to interrupt the boot process and gain access to those secrets.

Interception of the boot process is prevented in many computer systems by implementing a “secure (verified) boot chain of trust”, which is a process that starts at a hardware root of trust, such as a read-only-memory (ROM), and then proceeds through system firmware, to boot loaders, to the OS kernel, and to initial boot processes. Each component in the chain of trust verifies the integrity of the next component of the chain before transferring control to the next component. This chain of trust grows weaker the farther the process goes from the root of trust, as control is transferred to larger and more complex pieces of software, with more opportunities for security bugs or weaknesses. In a typical Linux™-based OS, secure boot typically does not extend beyond the OS kernel. Kernel parameters and an initial RAMdisk may or may not be verified as part of the secure boot process, as doing so interferes with the ability to customize the computing system. It is at this time, when the boot process changes from a deterministic sequential flow to a non-deterministic customizable flow, that secure boot protections are more easily attacked.

One countermeasure to apply to the weakness at this point in the boot process is to rely on manually-input passwords to unlock persistent storage which may be storing a secret. While these options may be effective for operator-at-the-keyboard scenarios such as when operating a personal laptop computer, these options are difficult to implement in Internet of Things (IoT) scenarios where the computing system may be in remote hard-to-reach areas and unattended boot processing is a system requirement.

When trust boundaries can be defined and secrets isolated from a general-purpose computing part of the computing system, embodiments described herein offer improved protection to filesystem-based secrets.

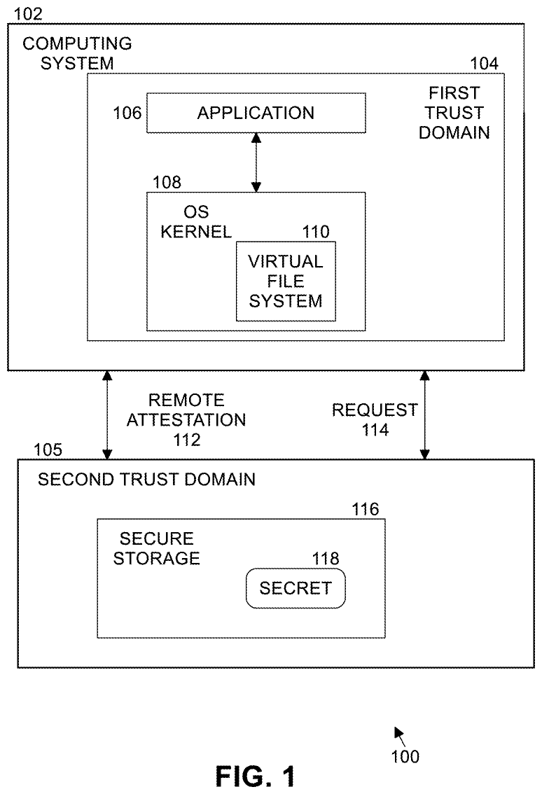

FIG. 1 is a diagram of a computing arrangement 100 according to some embodiments. Computing arrangement 100 includes at least one computing system 102 operating a first trust domain 104. A trust domain may be implemented by any suitable computer security mechanism. In an embodiment, implementing a trust domain is accomplished using Trust Domain Extensions (TDX) available from Intel Corporation. In other embodiments, other technologies may be used. For example, technologies such as the Intel® Dynamic Application Loader environment or TrustZone™ available from ARM Ltd. may be used. Computing system 102 includes one or more application(s) 106 and an OS kernel 108 being executed by at least one processing resource and stored in at least one storage device (the at least one processing resource and at least one storage device are omitted from FIG. 1 for clarity).

Computing system 102 can be embodied as any type of electronic device capable of performing data processing functions and making use of processing performed by a processing resource. For example, computing system 102 can be implemented as, without limitation, a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a disaggregated server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

It is to be appreciated that lesser or more equipped computing systems 102 than the examples described above may be preferred for certain implementations. Therefore, the configuration of computing system 102 can vary from implementation to implementation depending upon numerous factors, such as price constraints, performance requirements, technological improvements, or other circumstances.

OS kernel 108 manages secure booting of computing system 102 according to a chain of trust and may support secure processing for application 106 and/or for OS kernel 108. OS kernel 108 provides virtual file system (VFS) 110 to manage one or more files in computing system 102. In one scenario, application 106 reads data from a file in VFS 110 or writes data to a file in VFS 110 using one or more APIs provided by the VFS.

In an embodiment, application 106 sends a request to VFS 110 via OS kernel to access a secret. In some scenarios, the secret is stored in a file, either as cleartext or ciphertext. In some existing computing systems, the secret may be stored as cleartext in a storage location in computing system 102 that is accessible by application 106 or other software and/or hardware components of computing system 102, and thus may be open to attack, compromised or otherwise untrusted. In some other existing computing systems, the secret may be stored as ciphertext in a storage location in computing system 102 that may become compromised if an attacker is able to gain physical access to the computing system 102.

To overcome these security risks, in an embodiment secret 118 is stored in secure storage 116 in a second trust domain 105 (e.g., second trust domain 105 is different than first trust domain 104). In an embodiment, secure storage 116 may be implemented in a virtualization-based trusted execution environment (TEE). The secure storage mechanism may use hardware security modules (HSMs) or trusted platform modules (TPMs) to store hardware-protected wrapping keys to encrypt and decrypt the secrets stored in a conventional file system. If the amount of data involved is small, secure storage 116 may be implemented using the built-in storage of an HSM or a TPM to store the secrets directly on the hardware cryptographic device.

In an embodiment, second trust domain 105 is implemented in a different computing system than computing system 102. In another embodiment, second trust domain 105 is implemented in computing system 102 but is securely isolated from first trust domain 104. Second trust domain 105 receives request 114 to access secret 118, performs remote attestation processing with the requesting application 106 to authenticate the request and the requesting application prior to returning secret 118 to the requesting application. If the request or the requesting application is not authenticated during remote attestation processing, second trust domain 105 does not send secret 118 to the requesting application. In various embodiments, secret 118 is stored in a file, in a trusted platform module (TPM), in a hardware security module or a smart card supporting a public key cryptography standard (for example, PKCS11), or in another secure storage mechanism.

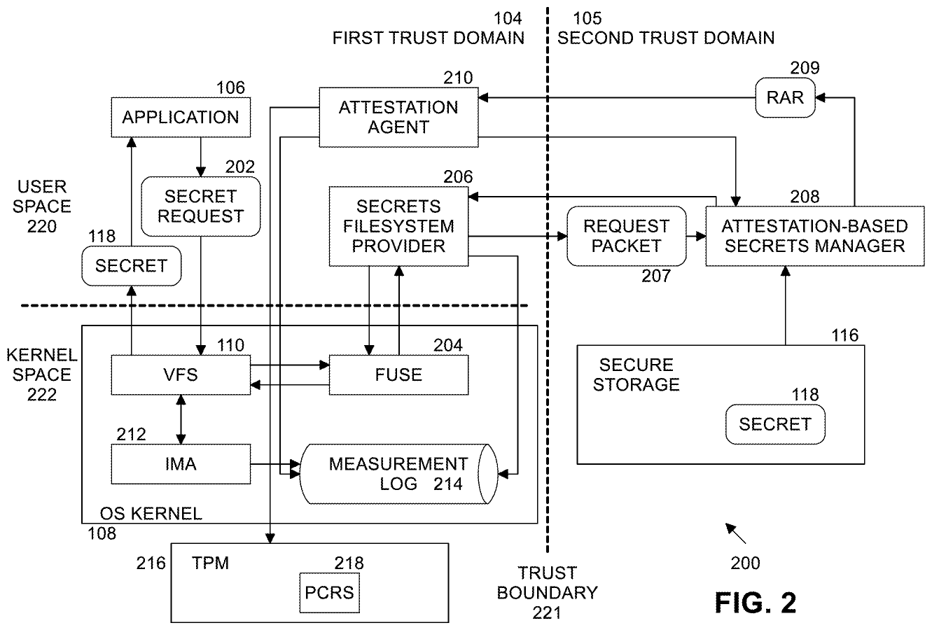

FIG. 2 is a block diagram of a computing system 200 having a filesystem (e.g., VFS 110) supporting remote-attestation-based secrets according to some embodiments. An application 106 that needs to access a secret 118 is launched in user space 220 by OS kernel 108 executing in (privileged) kernel space 222. Application 106 and OS kernel 108 are executing in first trust domain 104 behind logical trust boundary 221. As part of the launch process, the OS kernel, which is part of the secure boot chain and known to be trustworthy, measures application 106 using integrity measurement architecture (IMA) subsystem 212, stores the measurement in measurement log 214, and extends one or more platform configuration registers (PCRs) 218 in trusted platform module (TPM) 216. In an embodiment, IMA subsystem 212 is the Linux™ integrity measurement architecture. In an embodiment, measurement log 214 is implemented as described in the “Canonical Event Log Format” specification, version 1.0, revision 0.30, Dec. 11, 2020, and later versions, available from the Trusted Computing Group (TCG).

Additionally, other components involved, such as the secrets filesystem provider 206, runtime dependences that the application or the secrets filesystem provider may use (such as dynamic link libraries), configuration files, and system daemons that cause these components to run as part of the system boot process are also measured. As described further below, attestation-base secrets manager 208 can use information in the measurement log 214, an attestation quote or computing environmental factors (such as the request coming from a known network address or being received on a particular hardware interface) as factors in authorizing the release of the secret 118 to application 106.

Once launched, application 106 attempts to read secret 118 from VFS 110 at a predetermined path in the VFS by sending secret request 202 to the VFS. In an embodiment, access to secret 118 is specified in a path to a virtual file in VFS 110. Secret request 202 is handled by VFS 110 in OS kernel 108 and transferred to the filesystem in user space (FUSE) 204 subsystem. In an embodiment, FUSE 204 is an interface for user space programs to export a filesystem to the Linux™ kernel. FUSE 204 then calls secrets filesystem provider 206 in user space 220 to handle the request. During system initialization processing, secrets filesystem provider 206 was also measured by the IMA subsystem 212 of the OS kernel, the measurement for the secrets filesystem provider was added to the measurement log 214, and the measurement was extended into PCRs 218 of the TPM 216. The FUSE 204 subsystem provides information to secrets filesystem provider 206 to identify the requesting application 106 and details about the type of access being requested. Secrets filesystem provider 206 creates a request packet 207 cryptographically identifying the requester (e.g., using data obtained from measurement log 214 as measured by IMA subsystem 212), details about the request, anti-replay information, and (optionally) other data and sends the request packet to an attestation-based secrets manager 208.

In an embodiment, attestation-based secrets manager 208 executes in a separate trust domain, such as second trust domain 105. Second trust domain may be implemented as a TEE on computing system 102, or on a separate physical host that preserves the integrity of second trust domain 105 even if the requesting trust domain (e.g., first trust domain 104) is being actively attacked. Attestation-based secrets manager 208 sends a remote attestation request (RAR) 209 to attestation agent 210 running in user space 220 in first trust domain 104. Attestation agent 210 obtains an attestation quote from TPM 216 and obtains data describing application 106 from measurement log 214 (such as a PCR index, the hash extended into the PCR, a file hash, and a file path). The attestation quote and measurement log data are returned to attestation-based secrets manager 208.

In an embodiment, attestation-based secrets manager 208 checks one or more of: (a) that the attestation quote was issued from first trust domain 104; (b) the integrity of measurement log 214; (c) the cryptographic identity of the requester (that is, application 106); (d) the cryptographic integrity of secrets filesystem provider 206; (e) the integrity and identity of one or more of OS kernel 108, dynamic code libraries, system processes involved in launching other programs, and their respective configuration files; and (f) that the requested access is permitted by a policy.

In an embodiment, a policy is a logical expression that uses the provided information to determine a result on whether or not to permit access to the secret, or program logic to make the same decision. If application of the policy allows access, then access to the secret is allowed; otherwise access to the secret is not allowed. A policy may contain a list of cryptographic hashes of known valid system components that match those in the measurement log 214.

If all checks are passed, attestation-based secrets manager 208 gets secret 118 from secure storage 116 in second trust domain 105 and sends secret 118 to secrets filesystem provider 206. The response is returned to application 106 by unwinding the call stack (from secrets filesystem provider 206 to FUSE 204 to VFS 110 to application 106). When all checks are passed, the response to secret request 202 contains the requested secret 118.

In embodiments, the attestation-based authentication mechanism as described herein is a “zero trust” model that can detect tampering of the secure boot chain including system components involved in handling of secret request 202 (such as VFS 110, FUSE 204, secrets filesystem provider 206, and attestation agent 210). With an appropriate policy, secrets will not be disclosed to arbitrary processes (such as interactive shells) running in first trust domain 104. In an embodiment, a protection mechanism such as transport layer security (TLS) or kernel-mediated or hypervisor-mediated inter-process communication (IPC) may be used to protect secret 118 during communication between the two trust domains.

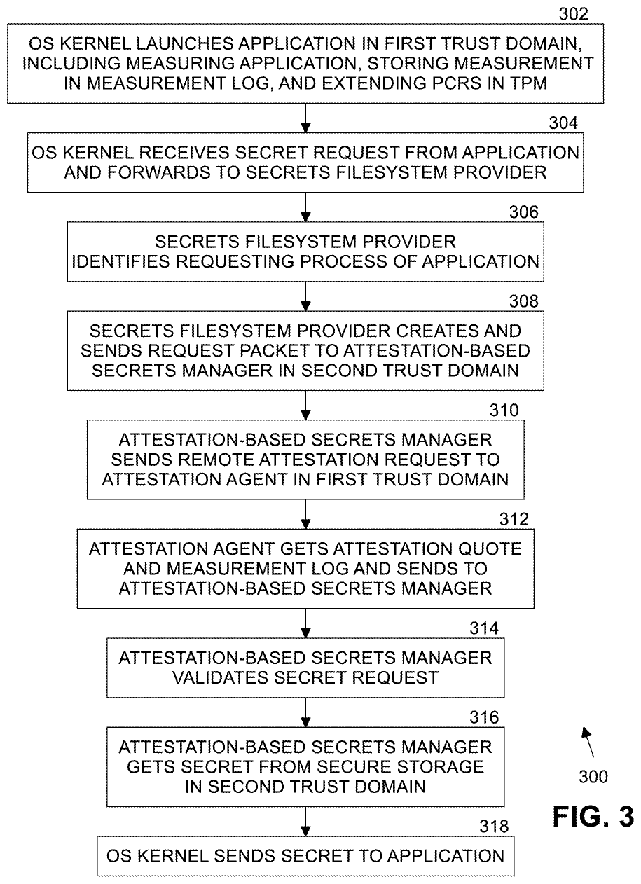

FIG. 3 is a flow diagram of remote attestation-based secrets processing 300 according to some embodiments. At block 302, OS kernel 108 launches application 106 in first trust domain 104. As part of the launch, the OS kernel, using IMA subsystem 212, measures the application to produce a measurement, stores the measurement in measurement log 214, and extends PCRs 218 in TPM 216 for the measurement. At block 304, OS kernel 108, via VFS 110, receives secret request 202 from application 106 and forwards the request to secrets filesystem provider 206. In an embodiment, VFS 110 forwards the request to FUSE 204, which forwards the request to secrets filesystem provider 206. At block 306, secrets filesystem provider 206 identifies the requesting process of application 106. In an embodiment, secrets filesystem provider 206 associates the secret request with a running process and may interrogate the OS kernel to further identify the application. At block 308, secrets filesystem provider 206 creates and sends a request packet 207 to attestation-based secrets manager 208 in second trust domain 105. At block 310, attestation-based secrets manager sends remote attestation request (RAR) 209 to attestation agent 210 in first trust domain 104.

At block 312, attestation agent 210 gets an attestation quote from TPM 216 and measurement log 214 and sends the attestation quote and the measurement log to attestation-based secrets manager 208. At block 314, attestation-based secrets manager 208 analyzes the secret request 202 using remote attestation methods based at least in part on the attestation quote and the measurement log, validates the request by evaluating a policy, and authorizes the release of the secret based at least in part on evaluating the policy. The verification process requires replaying the measurement log and ensuring that the measurement log produces the same PCR values that are in the attestation quote and that the quote is digitally signed by the first trust domain. At block 316, if the secret request is validated, attestation-based secrets manager 208 gets secret 118 from secure storage 116 in second trust domain 105. Attestation-based secrets manager 208 sends the secret back to secrets filesystem provider 206, which forwards the secret to FUSE 204 of OS kernel 108. At block 318, VFS 110 of OS kernel 108 sends the secret to application 106.

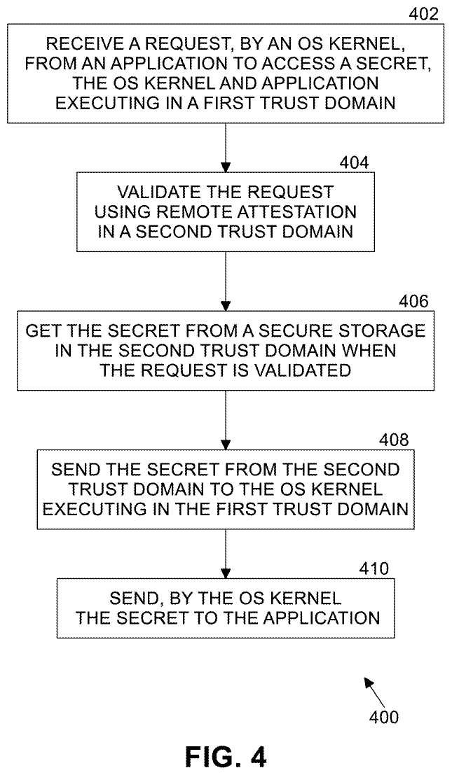

FIG. 4 is a flow diagram of remote attestation-based secrets processing 400 according to some embodiments. At block 402, secret request 202 is received from an application 106 to access secret 118 by OS kernel 108 executing in first trust domain 104. At block 404, the secret request is validated in second trust domain 105 using remote attestation. At block 406, secret 118 is obtained from secure storage 116 in second trust domain 105 when secret request 202 is validated. At block 408, the secret 118 is sent from second trust domain 105 through secrets filesystem provider 206 in user space 220 in first trust domain 104 to OS kernel 108 executing kernel space 222 in first trust domain 104. At block 410, secret 118 is sent by OS kernel 108 to application 106.

In an example use case, the technology disclosed herein may help to secure Kubernetes master nodes at the edge of an Internet of Things (IoT) computing system from privileged software adversaries but is also applicable to any computing architecture that stores critical secrets in plain text on the file system (as documented in Common Weakness Enumeration 313 Cleartext Storage in a File or on a Disk (CWE-313)).

Embodiments help to protect secrets by implementing the above-described remote attestation-based authentication mechanism mediated by the OS kernel to validate requests for the secrets.

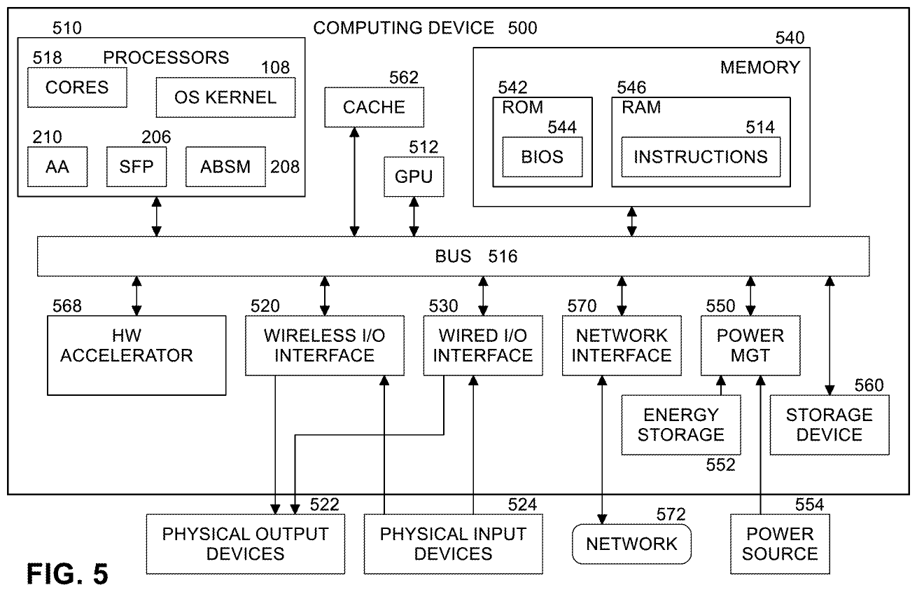

FIG. 5 is a schematic diagram of an illustrative electronic computing device to perform filesystem processing according to some embodiments. In some embodiments, computing device 500 includes one or more processors 510 including one or more processors cores 518, and one or more of OS kernel 108, attestation agent (AA) 210, secrets filesystem provider (SFP) 206, and attestation-based secrets manager (ABSM) 208. In some embodiments, the computing device 500 includes one or more hardware accelerators 568.

In some embodiments, the computing device is to implement filesystem processing, as provided in FIGS. 1-4 above.

The computing device 500 may additionally include one or more of the following: cache 562, a graphical processing unit (GPU) 512 (which may be the hardware accelerator in some implementations), a wireless input/output (I/O) interface 520, a wired I/O interface 530, system memory circuitry 540, power management circuitry 550, non-transitory storage device 560, and a network interface 570 for connection to a network 572. The following discussion provides a brief, general description of the components forming the illustrative computing device 500. Example, non-limiting computing devices 500 may include a desktop computing device, blade server device, workstation, laptop computer, mobile phone, tablet computer, personal digital assistant, or similar device or system.

In embodiments, the processor cores 518 are capable of executing machine-readable instruction sets 514, reading data and/or instruction sets 514 from one or more storage devices 560 and writing data to the one or more storage devices 560. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 514 may include instructions to implement filesystem processing, as provided in FIGS. 1-4.

The processor cores 518 may include any number of hardwired or configurable circuits, some or all of which may include programmable and/or configurable combinations of electronic components, semiconductor devices, and/or logic elements that are disposed partially or wholly in a PC, server, mobile phone, tablet computer, or other computing system capable of executing processor-readable instructions.

The computing device 500 includes a bus or similar communications link 516 that communicably couples and facilitates the exchange of information and/or data between various system components including the processor cores 518, the cache 562, the graphics processor circuitry 512, one or more wireless I/O interfaces 520, one or more wired I/O interfaces 530, one or more storage devices 560, and/or one or more network interfaces 570. The computing device 500 may be referred to in the singular herein, but this is not intended to limit the embodiments to a single computing device 500, since in certain embodiments, there may be more than one computing device 500 that incorporates, includes, or contains any number of communicably coupled, collocated, or remote networked circuits or devices.

The processor cores 518 may include any number, type, or combination of currently available or future developed devices capable of executing machine-readable instruction sets.

The processor cores 518 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 5 are of conventional design. Consequently, such blocks need not be described in further detail herein, as they will be understood by those skilled in the relevant art. The bus 516 that interconnects at least some of the components of the computing device 500 may employ any currently available or future developed serial or parallel bus structures or architectures.

The system memory circuitry 540 may include read-only memory (“ROM”) 542 and random-access memory (“RAM”) 546. A portion of the ROM 542 may be used to store or otherwise retain a basic input/output system (“BIOS”) 544. The BIOS 544 provides basic functionality to the computing device 500, for example by causing the processor cores 518 to load and/or execute one or more machine-readable instruction sets 514. In embodiments, at least some of the one or more machine-readable instruction sets 514 cause at least a portion of the processor cores 518 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 500 may include at least one wireless input/output (I/O) interface 520. The at least one wireless I/O interface 520 may be communicably coupled to one or more physical output devices 522 (tactile devices, video displays, audio output devices, hardcopy output devices, etc.). The at least one wireless I/O interface 520 may communicably couple to one or more physical input devices 524 (pointing devices, touchscreens, keyboards, tactile devices, etc.). The at least one wireless I/O interface 520 may include any currently available or future developed wireless I/O interface. Example wireless I/O interfaces include, but are not limited to: BLUETOOTH®, near field communication (NFC), and similar.

The computing device 500 may include one or more wired input/output (I/O) interfaces 530. The at least one wired I/O interface 530 may be communicably coupled to one or more physical output devices 522 (tactile devices, video displays, audio output devices, hardcopy output devices, etc.). The at least one wired I/O interface 530 may be communicably coupled to one or more physical input devices 524 (pointing devices, touchscreens, keyboards, tactile devices, etc.). The wired I/O interface 530 may include any currently available or future developed I/O interface. Example wired I/O interfaces include but are not limited to universal serial bus (USB), IEEE 1394 (“FireWire”), and similar.

The computing device 500 may include one or more communicably coupled, non-transitory, data storage devices 560. The data storage devices 560 may include one or more hard disk drives (HDDs) and/or one or more solid-state storage devices (SSDs). The one or more data storage devices 560 may include any current or future developed storage appliances, network storage devices, and/or systems. Non-limiting examples of such data storage devices 560 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 560 may include one or more removable storage devices, such as one or more flash drives, flash memories, flash storage units, or similar appliances or devices capable of communicable coupling to and decoupling from the computing device 500.

The one or more data storage devices 560 may include interfaces or controllers (not shown) communicatively coupling the respective storage device or system to the bus 516. The one or more data storage devices 560 may store, retain, or otherwise contain machine-readable instruction sets, data structures, program modules, data stores, databases, logical structures, and/or other data useful to the processor cores 518 and/or graphics processor circuitry 512 and/or one or more applications executed on or by the processor cores 518 and/or graphics processor circuitry 512 or storage device controller 112. In some instances, one or more data storage devices 560 may be communicably coupled to the processor cores 518, for example via the bus 516 or via one or more wired communications interfaces 530 (e.g., Universal Serial Bus or USB); one or more wireless communications interfaces 520 (e.g., Bluetooth®, Near Field Communication or NFC); and/or one or more network interfaces 570 (IEEE 802.3 or Ethernet, IEEE 802.11, or Wi-Fi®, etc.).

Processor-readable instruction sets 514 and other programs, applications, logic sets, and/or modules may be stored in whole or in part in the system memory circuitry 540. Such instruction sets 514 may be transferred, in whole or in part, from the one or more data storage devices 560. The instruction sets 514 may be loaded, stored, or otherwise retained in system memory circuitry 540, in whole or in part, during execution by the processor cores 518 and/or graphics processor circuitry 512.

The computing device 500 may include power management circuitry 550 that controls one or more operational aspects of the energy storage device 552. In embodiments, the energy storage device 552 may include one or more primary (i.e., non-rechargeable) or secondary (i.e., rechargeable) batteries or similar energy storage devices. In embodiments, the energy storage device 552 may include one or more supercapacitors or ultracapacitors. In embodiments, the power management circuitry 550 may alter, adjust, or control the flow of energy from an external power source 554 to the energy storage device 552 and/or to the computing device 500. The power source 554 may include, but is not limited to, a solar power system, a commercial electric grid, a portable generator, an external energy storage device, or any combination thereof.

For convenience, the processor cores 518, the graphics processor circuitry 512, the wireless I/O interface 520, the wired I/O interface 530, the storage device 560, and the network interface 570 are illustrated as communicatively coupled to each other via the bus 516, thereby providing connectivity between the above-described components. In alternative embodiments, the above-described components may be communicatively coupled in a different manner than illustrated in FIG. 5. For example, one or more of the above-described components may be directly coupled to other components, or may be coupled to each other, via one or more intermediary components (not shown). In another example, one or more of the above-described components may be integrated into the processor cores 518 and/or the graphics processor circuitry 512. In some embodiments, all or a portion of the bus 516 may be omitted and the components are coupled directly to each other using suitable wired or wireless connections.

Flowcharts representative of example hardware logic, machine readable instructions, hardware implemented state machines, and/or any combination thereof for implementing computing device 500, for example, are shown in FIGS. 3 and 4. The machine-readable instructions may be one or more executable programs or portion(s) of an executable program for execution by a computer processor such as the processor 510 shown in the example computing device 500 discussed above in connection with FIG. 5. The program may be embodied in software stored on a non-transitory computer readable storage medium such as a CD-ROM, a floppy disk, a hard drive, a DVD, a Blu-ray disk, or a memory associated with the processor 510, but the entire program and/or parts thereof could alternatively be executed by a device other than the processor 510 and/or embodied in firmware or dedicated hardware. Further, although the example program is described with reference to the flowcharts illustrated in FIGS. 3 and 4, many other methods of implementing the example computing devices 500 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3 and 4 may be implemented using executable instructions (e.g., computer and/or machine-readable instructions) stored on a non-transitory computer and/or machine-readable medium such as a hard disk drive, a solid-state storage device (SSD), a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments. Example 1 is a method including receiving a request, by an operating system kernel, from an application to access a secret, the application and operating system kernel executing in a first trust domain; validating the request using remote attestation in a second trust domain; getting the secret from a secure storage in the second trust domain when the request is validated; sending the secret from the second trust domain to the operating system kernel; and sending, by the operating system kernel, the secret to the application.

In Example 2, the subject matter of Example 1 can optionally include measuring the application to produce a measurement, storing the measurement in a measurement log, and extending platform configuration registers (PCRs) in a trusted platform module (TPM) for the measurement.

In Example 3, the subject matter of Example 2 can optionally include wherein a virtual file system (VFS) of the operating system kernel receives the request and forwards the request to a secrets filesystem provider executing in the first trust domain via a filesystem in user space (FUSE) subsystem.

In Example 4, the subject matter of Example 3 can optionally include identifying, by the secrets filesystem provider, a requesting process of the application.

In Example 5, the subject matter of Example 3 can optionally include creating and sending a request packet, by the secrets filesystem provider, to an attestation-based secrets manager executing in the second trust domain.

In Example 6, the subject matter of Example 5 can optionally include sending, by the attestation-based secrets manager, a remote attestation request to an attestation agent executing in the first trust domain to get an attestation quote for the secret request; getting, by the attestation agent, the attestation quote from the TPM and the measurement log and sending the attestation quote to the attestation-based secrets manager; analyzing the attestation quote, by the attestation-based secrets manager, using remote attestation based at least in part on the attestation quote and the measurement log, to validate the secret request; getting, by the attestation-based secrets manager, the secret from the secure storage when the secret request is validated; and sending, by the attestation-based secrets manager, the secret to the secrets filesystem provider.

In Example 7, the subject matter of Example 6 can optionally include sending, by the secrets filesystem provider, the secret to the FUSE subsystem; sending, by the FUSE subsystem, the secret to the VFS; and sending, by the VFS, the secret to the application.

In Example 8, the subject matter of Example 7 can optionally include wherein the operating system kernel is in kernel space of the first trust domain, and the application, the attestation agent, and the secrets filesystem provider are in user space of the first trust domain.

In Example 9, the subject matter of Example 1 can optionally include wherein the secret is stored in a file on the secure storage.

In Example 10, the subject matter of Example 1 can optionally include wherein the first trust domain is in a first computing system and the second trust domain is in a second computing system.

In Example 11, the subject matter of Example 1 can optionally include wherein the first trust domain is in a first computing system and the second trust domain is in a second computing system.

Example 12 is at least one non-transitory machine-readable storage medium comprising instructions that, when executed, cause at least one processing device to at least: receive a request, by an operating system kernel, from an application to access a secret, the application and operating system kernel executing in a first trust domain; validate the request using remote attestation in a second trust domain; get the secret from a secure storage in the second trust domain when the request is validated; send the secret from the second trust domain to the operating system kernel; and send, by the operating system kernel, the secret to the application.

In Example 13, the subject matter of Example 12 can optionally include instructions to measure the application to produce a measurement, store the measurement in a measurement log, and extend platform configuration registers (PCRs) in a trusted platform module (TPM) for the measurement.

In Example 14, the subject matter of Example 13 can optionally include wherein a virtual file system (VFS) of the operating system kernel includes instructions to receive the request and forward the request to a secrets filesystem provider executing in the first trust domain via a filesystem in user space (FUSE) subsystem.

In Example 15, the subject matter of Example 14 can optionally include instructions to create and send a request packet, by the secrets filesystem provider, to an attestation-based secrets manager executing in the second trust domain.

In Example 16, the subject matter of Example 15 can optionally include instructions to send, by the attestation-based secrets manager, a remote attestation request to an attestation agent executing in the first trust domain to get an attestation quote for the secret request; get, by the attestation agent, the attestation quote from the TPM and the measurement log and sending the attestation quote to the attestation-based secrets manager; analyze the attestation quote, by the attestation-based secrets manager, using remote attestation based at least in part on the attestation quote and the measurement log, to validate the secret request; get, by the attestation-based secrets manager, the secret from the secure storage when the secret request is validated; and send, by the attestation-based secrets manager, the secret to the secrets filesystem provider.

In Example 17, the subject matter of Example 16 can optionally include instructions to send, by the secrets filesystem provider, the secret to the FUSE subsystem; send, by the FUSE subsystem, the secret to the VFS; and send, by the VFS, the secret to the application.

Example 18 is a computing system, comprising an operating system kernel to receive a request from an application to access a secret, the application and the operating system kernel executing in a first trust domain; and an attestation-based secrets manager executing in a second trust domain to receive the request from the operating system kernel, validate the request using remote attestation, get the secret from a secure storage in the second trust domain when the request is validated, and send the secret from the second trust domain to the operating system kernel; wherein the operating system kernel is to send the secret to the application.

In Example 19, the subject matter of Example 13 can optionally include wherein the operating system kernel comprises an integrity measurement architecture subsystem to measure the application to produce a measurement, store the measurement in a measurement log, and extend platform configuration registers (PCRs) in a trusted platform module (TPM) for the measurement.

In Example 20, the subject matter of Example 19 can optionally include wherein the operating system kernel comprises a virtual file system (VFS) to receive the request and forward the request to a secrets filesystem provider executing in the first trust domain via a filesystem in user space (FUSE) subsystem.

In Example 21, the subject matter of Example 20 can optionally include wherein the secrets filesystem provider is to create and send a request packet to the attestation-based secrets manager.

In Example 22, the subject matter of Example 21 can optionally include the attestation-based secrets manager is to send a remote attestation request to an attestation agent executing in the first trust domain to get an attestation quote for the secret request; the attestation agent is to get the attestation quote from the TPM and the measurement log and send the attestation quote to the attestation-based secrets manager; and the attestation-based secrets manager is to analyze the attestation quote, using remote attestation based at least in part on the attestation quote and the measurement log, to validate the secret request, get the secret from the secure storage when the secret request is validated, and send the secret to the secrets filesystem provider.

In Example 23, the subject matter of Example 22 can optionally include the secrets filesystem provider is to send the secret to the FUSE subsystem; the FUSE subsystem is to send the secret to the VFS; and the VFS is to send the secret to the application.

Example 24 is an apparatus including means for performing the actions of Example 1.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. A method comprising:
receiving a request, by an operating system kernel, from an application to access a secret, the application and operating system kernel executing in a first trust domain;
validating the request using remote attestation in a second trust domain;
getting the secret from a secure storage in the second trust domain when the request is validated;
sending the secret from the second trust domain to the operating system kernel; and
sending, by the operating system kernel, the secret to the application.

2. The method of claim 1, further comprising:
measuring the application to produce a measurement, storing the measurement in a measurement log, and extending platform configuration registers (PCRs) in a trusted platform module (TPM) for the measurement.

3. The method of claim 2, wherein a virtual file system (VFS) of the operating system kernel receives the request and forwards the request to a secrets filesystem provider executing in the first trust domain via a filesystem in user space (FUSE) subsystem.

4. The method of claim 3, comprising:
identifying, by the secrets filesystem provider, a requesting process of the application.

5. The method of claim 3, comprising:
creating and sending a request packet, by the secrets filesystem provider, to an attestation-based secrets manager executing in the second trust domain.

6. The method of claim 5, comprising:
sending, by the attestation-based secrets manager, a remote attestation request to an attestation agent executing in the first trust domain to get an attestation quote for the secret request;
getting, by the attestation agent, the attestation quote from the TPM and the measurement log and sending the attestation quote to the attestation-based secrets manager;
analyzing the attestation quote, by the attestation-based secrets manager, using remote attestation based at least in part on the attestation quote and the measurement log, to validate the secret request;
getting, by the attestation-based secrets manager, the secret from the secure storage when the secret request is validated; and
sending, by the attestation-based secrets manager, the secret to the secrets filesystem provider.

7. The method of claim 6, comprising:
sending, by the secrets filesystem provider, the secret to the FUSE subsystem;
sending, by the FUSE subsystem, the secret to the VFS; and
sending, by the VFS, the secret to the application.

8. The method of claim 7, wherein the operating system kernel is in kernel space of the first trust domain, and the application, the attestation agent, and the secrets filesystem provider are in user space of the first trust domain.

9. The method of claim 1, wherein the secret is stored in a file on the secure storage.

10. The method of claim 1, wherein the first trust domain is in a first computing system and the second trust domain is in a second computing system.

11. The method of claim 1, wherein the first trust domain is in a first computing system and the second trust domain is in a second computing system.

12. At least one non-transitory machine-readable storage medium comprising instructions that, when executed, cause at least one processing device to at least:
receive a request, by an operating system kernel, from an application to access a secret, the application and operating system kernel executing in a first trust domain;
validate the request using remote attestation in a second trust domain;
get the secret from a secure storage in the second trust domain when the request is validated;
send the secret from the second trust domain to the operating system kernel; and
send, by the operating system kernel, the secret to the application.

13. The at least one non-transitory machine-readable storage medium of claim 12, further comprising instructions to:
measure the application to produce a measurement, store the measurement in a measurement log, and extend platform configuration registers (PCRs) in a trusted platform module (TPM) for the measurement.

14. The at least one non-transitory machine-readable storage medium of claim 13, wherein a virtual file system (VFS) of the operating system kernel includes instructions to receive the request and forward the request to a secrets filesystem provider executing in the first trust domain via a filesystem in user space (FUSE) subsystem.

15. The at least one non-transitory machine-readable storage medium of claim 14, further comprising instructions to:
create and send a request packet, by the secrets filesystem provider, to an attestation-based secrets manager executing in the second trust domain.

16. The at least one non-transitory machine-readable storage medium of claim 15, further comprising instructions to:
send, by the attestation-based secrets manager, a remote attestation request to an attestation agent executing in the first trust domain to get an attestation quote for the secret request;
get, by the attestation agent, the attestation quote from the TPM and the measurement log and sending the attestation quote to the attestation-based secrets manager;
analyze the attestation quote, by the attestation-based secrets manager, using remote attestation based at least in part on the attestation quote and the measurement log, to validate the secret request;
get, by the attestation-based secrets manager, the secret from the secure storage when the secret request is validated; and
send, by the attestation-based secrets manager, the secret to the secrets filesystem provider.

17. The at least one non-transitory machine-readable storage medium of claim 16, further comprising instructions to:
send, by the secrets filesystem provider, the secret to the FUSE subsystem;
send, by the FUSE subsystem, the secret to the VFS; and
send, by the VFS, the secret to the application.

18. An apparatus comprising:
a processor; and
a memory device coupled to the processor, the memory device having instructions stored thereon that, in response to execution by the processor, cause the processor to:
receive a request from an application to access a secret, the application executing in a first trust domain; and
receive the request in a second trust domain, validate the request using remote attestation, get the secret from a secure storage in the second trust domain when the request is validated, and send the secret from the second trust domain to the application in the first trust domain.

19. The apparatus of claim 18, comprising instructions when executed to measure the application to produce a measurement, store the measurement in a measurement log, and extend platform configuration registers (PCRs) in a trusted platform module (TPM) for the measurement.

20. The apparatus of claim 19, comprising instructions when executed to receive the request and forward the request to a secrets filesystem provider executing in the first trust domain via a filesystem in user space (FUSE) subsystem.
